(19) United States
(12) Patent Application Publication
(10) Pub. No.: US 2003/0123352 A1
(43) Pub. Date: Jul. 3, 2003

(54) Method for controlling writing power in CAV mode

(76) Inventor: Chien-Shou Chen, Chi-Lung City (TW)

Correspondence Address: NAIPO (NORTH AMERICA INTERNATIONAL PATENT OFFICE), P.O. BOX 506, MERRIFIELD, VA, 22116, US

(21) Appl. No.: 10/065,105

(22) Filed: Sep. 18, 2002

(30) Foreign Application Priority Data
Dec. 28, 2001 (TW) 090133001

(51) Int. Cl. G11B 7/125

(52) U.S. Cl. 369/47.53

(57) ABSTRACT

A method for controlling a laser power of a compact disc recorder in a constant angular velocity (CAV) mode. Two different reference writing powers corresponding to two reference linear velocities at an inner and an outer radius of a compact disc are determined by an optimum power control (OPC) procedure. A reference table is constructed according to the two reference writing powers and the two reference linear velocities. The reference table has a plurality of reference linear velocities and each of which has a corresponding reference writing power and a reference reflected pulse level. The optimum writing power and target reflected pulse level of the desired data is determined by the reference table. A running optimum power control (ROPC) procedure is performed to write the desired data onto the compact disc according to the determined writing power and reflected pulse level.

### BACKGROUND OF INVENTION

1.Field of the Invention

The present invention relates to a writing power control method, and more specifically, the present invention discloses a method for controlling the laser power of a compact disc recorder operating in a constant angular velocity (CAV) mode.

2. Description of the Prior Art

A compact disc recorder has a pick-up head, which emits a laser beam to etch the recording layer of a compact disc for storing data in a digital format. A pit on the compact disc represents “0”, and a land of the compact disc represents “1”. However, for different compact discs, the laser beam has different energy absorption characteristics due to different properties in the recording layers. Accordingly, when the same laser beam illuminates on different kinds of compact discs, different levels of etching will be produced. As a result, when the compact discs are manufactured, manufacturers usually record a desired writing power for the compact disc in a lead-in area of the compact disc to serve as a reference. Additionally, the compact disc recorders produced by different manufacturers also utilize an optimum power control (OPC) procedure and a running power control (ROPC) procedure to ensure accuracy of the etching results. As to the preferred method of performing the OPC and ROPC procedures, details can be found in the Orange Book and are summarized as follows.

As the Orange Book discloses, the OPC procedure and the ROPC procedure can be used for controlling the writing power of the compact disc recorder in a constant linear velocity (CLV) mode, which is an updated writing mode used by the compact disc recorder. In such mode, a driving motor controls the spin velocity of the compact disc to maintain a constant linear velocity to perform data writing operations.

Before writing data onto the compact disc, the OPC procedure first transfers a power calibration area (PCA) of the compact disc to the constant linear velocity, and then utilizes different writing powers (usually fifteen of them) to perform a writing test procedure in the PCA and retrieves the test results to select a suitable writing power corresponding to the CLV from the different writing powers available.

In general, after performing the OPC procedure, the aforementioned ROPC procedure must be additionally performed due to various compositions of the compact disc itself or an influence creating an unstable writing power, which can occur by temperature influencing the pick-up head or the dust on the compact disc. The ROPC procedure is used to perform an on-line adjustment of the writing power determined by the OPC procedure according to a target reflected pulse level stored in the lead-in area of the compact disc when the compact disc recorder writes data onto the compact disc. Furthermore, when the compact disc recorder writes data onto the compact disc using CLV, the pick-up head emits an incident write pulse to etch the compact disc. The incident write pulse will be reflected to form a reflected pulse through the compact disc, and a reflected pulse level of the reflected pulse, which is a β-level as disclosed in the Orange Book, represents depth of etching on the compact disc. When the ROPC procedure is performed, the compact disc recorder will compare the reflected pulse level with the target reflected pulse level recorded on the compact disc to adjust the writing power of the pick-up head, and to maintain the reflected pulse level at a suitable value so as to ensure the accuracy of the etching on the compact disc.

In parallel with development of the access speed of the compact disc recorder, the fast writing velocity of the compact disc recorder is not easily increased under the conventional CLV mode, and the reasons are summarized as follows. When the CLV mode is utilized, the spin velocity of the driving motor needs be continuously accelerated in order to maintain the constant linear velocity, since the linear velocity of the CLV mode is constant. That is, when the compact disc recorder performs a burning procedure at an outer radius of the compact disc, the spin velocity of the driving motor must be high enough to maintain a high linear velocity.

As a result, a constant angular velocity (CAV) control mode is provided to solve above-mentioned problems. Under the CAV mode, the spin velocity of the driving motor is constant. Therefore, it does not need to continuously change the spin velocity of the driving motor as does the compact disc recorder with a CLV mode when the pick-up head accesses the compact disc.

Under the operation of the CAV mode, the spin velocity of the driving motor is constant so that different locations on the compact disc have different linear velocities. Accordingly, if the writing power of the compact disc recorder can also be changed along with the changing linear velocities, better burning quality will be obtained so as to increase the data accessing rate of the compact disc. As mentioned above, the conventional OPC procedure utilizes a certain constant linear velocity to obtain an appropriate writing power for that certain constant linear velocity, but cannot get appropriate writing powers with respect to each of the linear velocities on the compact disc.

Additionally, when performing the ROPC procedure, an obtained OPC value and the target reflected pulse level are used to adjust the writing power. However, variation of the linear velocities are large so that if only the obtained OPC value is used to perform the writing procedure, the ROPC procedure cannot adjust the writing power correctly due to variations in the linear velocities. Furthermore, each of the linear velocities has a different reflected pulse level. Therefore, if a constant target reflected pulse level is used, the writing results may vary. Accordingly, designing a suitable power calibration method for a compact disc recorder operating under CAV mode is of prime concern to manufacturers.

### SUMMARY OF INVENTION

It is therefore a primary objective of the claimed invention to provide a method to control the laser power during the operation of a constant angular velocity (CAV) mode. The method first constructs a reference table before writing data onto a compact disc (CD). Then, utilizes the reference table to find corresponding writing powers and target reflected pulse levels for each of the linear velocities to write data onto to the compact-disc using a running optimum power control (ROPC) procedure.

The claimed invention, briefly summarized, discloses a method for controlling the laser power of a CD recorder in a constant angular velocity (CAV) mode. In the method, two different reference writing powers corresponding to two reference linear velocities are determined by an optimum power control (OPC) procedure. The two reference linear velocities are defined as the linear velocity of a compact disc at an inner radius and an outer radius respectively. Then, a reference table is constructed according to the two reference writing powers and the two reference linear velocities. The reference table has a plurality of reference linear velocities to divide the compact disc into a plurality of zones, and each of the linear velocities has a corresponding reference writing power and a reference reflected pulse level. Finally, an optimum writing power and a target reflected pulse level of a desired data is determined according to the reference table. A running optimum power control (ROPC) procedure is then performed to write the desired data onto the compact disc according to the determined optimum writing power and target reflected pulse level.

It is an advantage that the claimed invention constructs a reference table to determine reference writing powers and reference reflected pulse levels with respect to the reference linear velocities before writing data onto a compact disc. Then, to utilize the reference table to obtain the optimum writing power and the target reflected pulse level of certain desired data to perform the ROPC procedure to write data onto the compact disc. Therefore, the writing power control method of the present invention can easily and accurately adjust the writing power and the target reflected pulse level of linear velocities at different locations of the compact disc so as to ensure the accuracy of the writing results and increase efficiency of the whole system substantially.

These and other objectives and advantages of the claimed invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a diagram of a recordable compact disc.

FIG. 2 is a reference table of the control parameters according to the present invention.

FIG. 3 is a flow chart of a writing power control method according to the present invention.

### DETAILED DESCRIPTION

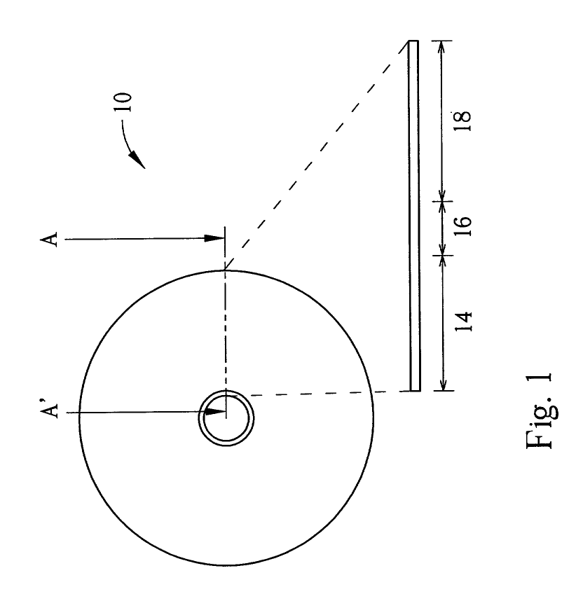

Please refer to FIG. 1. FIG. 1 is a diagram of a recordable compact disc 10. The compact disc 10 comprises a power calibration area (PCA) 14 for calibrating a writing power, a lead-in area 16 for recording a reference writing power of the compact disc 10, and a program area 18 for a user to write data onto the compact disc 10.

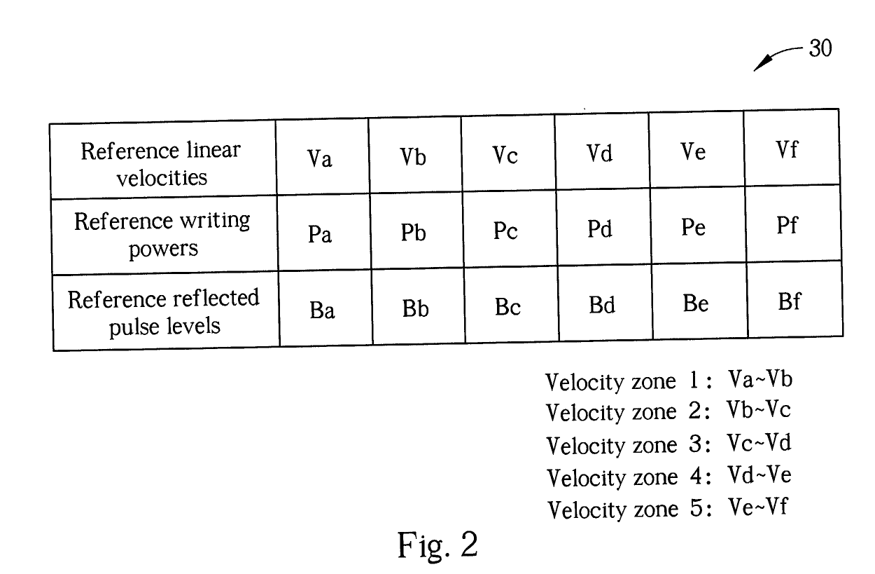

Please refer to FIG. 2. FIG. 2 is a reference table 30 of three control parameters according to the present invention. In general, the present invention first obtains a plurality of corresponding control parameters before writing data onto the compact disc 10. Then, the present invention finds corresponding writing powers and target reflected pulse levels of desired data for each of the linear velocities to write data onto to the compact disc 10 according to the control parameters. The plurality of control parameters is illustrated in the reference table 30. As shown in FIG. 2, the reference table 30 comprises a plurality of reference linear velocities Va, Vb, Vc, Vd, Ve, and Vf dividing the program area 18 of the compact disc 10 into five velocity zones Va˜Vb, Vb˜Vc, Vc˜Vd, Vd˜Ve, and Ve˜Vf. Each of the reference linear velocities Va, Vb, Vc, Vd, Ve, and Vf has a respective reference writing power Pa, Pb, Pc, Pd, Pe and Pf and a reference reflected pulse level Ba, Bb, Bc, Bd, Be and Bf stored in the reference table 30. The reference writing powers Pa, Pb, Pc, Pd, Pe and Pf are used to determine an optimum writing power of the desired data, and the reference reflected pulse levels Ba, Bb, Bc, Bd, Be, and Bf are used to determine a target reflected pulse level of the desired data so as to perform a running optimum power control (ROPC) procedure.

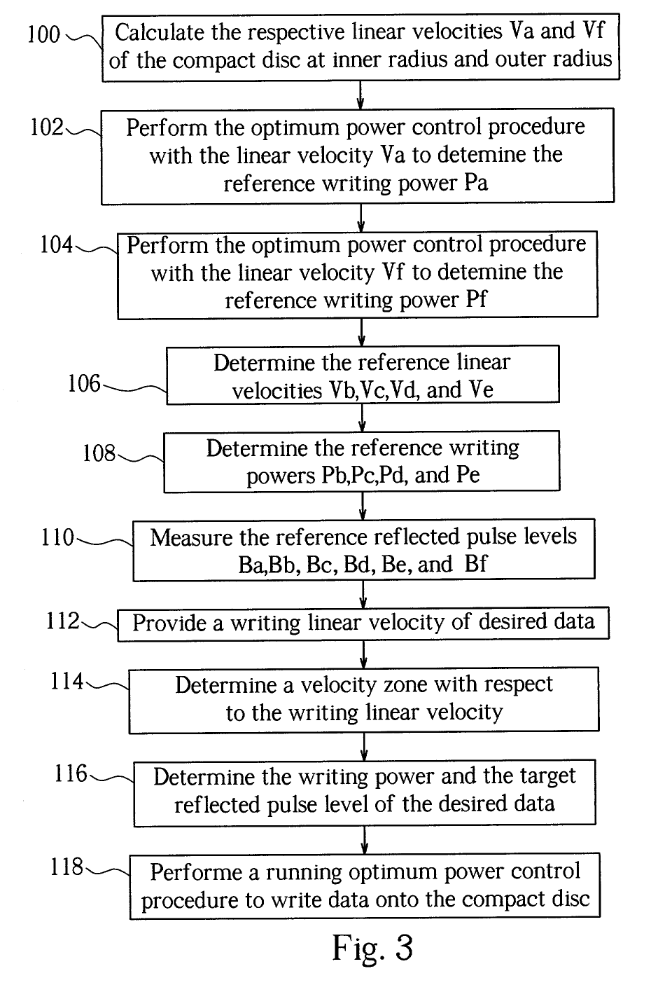

Please refer to FIG. 3. FIG. 3 is a flow chart of a writing power control method according to the present invention. Summarizations of each step according to the present invention are as follows.

Step 100:

Calculate the respective linear velocities Va and Vf of the compact disc 10 at an inner radius and an outer radius for writing data onto the compact disc 10 according to a spin velocity of the compact disc recorder under a constant angular velocity (CAV) mode.

Step 102:

Perform an optimum power control (OPC) procedure in the PCA 14 using the linear velocity Va to determine the reference writing power Pa.

Step 104:

Perform the OPC procedure in the PCA 14 using the linear velocity Vf to determine the reference writing power Pf.

Step 106:

Determine the reference linear velocities Vb, Vc, Vd and Ve according to the linear velocities Va and Vf.

Step 108:

Determine the reference writing powers Pb, Pc, Pd and Pe according to the reference writing powers Pa and Pf.

Step 110:

Perform a writing test procedure in the PCA 14 using the reference linear velocities Va, Vb, Vc, Vd, Ve and Vf and the corresponding reference writing powers Pa, Pb, Pc, Pd, Pe and Pf, and retrieve the corresponding reflected pulses to determine the reference reflected pulse levels Ba, Bb, Bc, Bd, Be and Bf corresponding to the reference linear velocities Va, Vb, Vc, Vd, Ve and Vf.

Step 112:

Provide a writing linear velocity of a desired data to be written into according to the spin velocity of the driving motor and the location of the pick-up head.

Step 114:

Determine a velocity zone with respect to the writing linear velocity and interpolating the two reference linear velocities with respect to the velocity zone, according to the reference table 30.

Step 116:

Determine the optimum writing power and the target reflected pulse level of the desired data according to the reference writing powers and the reference reflected pulse levels corresponding to the two reference linear velocities.

Step 118:

Perform a running optimum power control (ROPC) procedure to write data onto the compact disc 10.

The above-mentioned steps, from step 100 to step 110, are used to determine each of the control parameters shown in the reference table 30 of FIG. 2. First, to determine a maximum linear velocity Va and a minimum linear velocity Vf of the compact disc 10. In general, under an operation in a CAV mode, the angular velocity is constant so that a first reference linear velocity Va can be obtained at or close to the center of the compact disc 10, and a second reference linear velocity Vf can be obtained adjacent to or close to the outermost radius of the compact disc 10. For example, under an operation of a certain CAV mode, the linear velocities from an inner radius to an outer radius increase from Va to Vf, normally from 2 to 5 times.

Step 102 adjusts the spin velocity of the rotational spindle of the compact disc recorder making the linear velocity of the PCA 14 on the compact disc 10 equal to the first reference linear velocity Va, and performing the OPC procedure to obtain the reference writing power Pa corresponding to the linear velocity Va. As the prior art described, the OPC procedure utilizes different writing powers to perform a writing test procedure and retrieves the test results to obtain a suitable writing power with respect to the linear velocity. Step 104 adjusts the spin velocity of the rotational spindle making the linear velocity of the PCA 14 on the compact disc 10 equal to the second reference linear velocity Vf and performs the OPC procedure to obtain the reference writing power Pf corresponding to the linear velocity Vf. In general, step 102 and step 104 first utilize the PCA 14 to simulate a rotational situation of the compact disc 10 during the operation of the first linear velocity Va to obtain the first writing power Pa and then to utilize the PCA 14 to simulate the rotational situation of the compact disc 10 during the operation of the second linear velocity Vf to obtain the second writing power Pf.

After obtaining the first and second linear velocities Va and Vf, step 106 determines other reference linear velocities Vb, Vc, Vd and Ve. In the preferred embodiment of the present invention, the linear velocities Vb, Vc, Vd and Ve are distributed between the minimum writing linear velocity Va and the maximum writing linear velocity Vf in equidistance to divide the program area 18 of the compact disc 10 into five velocity zones. Similarly, step 108 is to determine the writing powers Pb, Pc, Pd and Pe distributed between the minimum writing power Pa and the maximum writing power Pf in equidistance.

Step 110 is to utilize the linear velocities Va, Vb, Vc, Vd, Ve and Vf and the corresponding reference writing powers Pa, Pb, Pc, Pd, Pe and Pf to perform the writing test procedure in the PCA 1 4. This procedure retrieves the corresponding reflected pulses to determine the reference reflected pulse levels Ba, Bb, Bc, Bd, Be and Bf corresponding to the linear velocities Va, Vb, Vc, Vd, Ve and Vf respectively, allowing completion of the reference table 30.

After the reference table 30 is constructed, the compact disc recorder can begin to perform a data programming procedure. At this time, the rotational speed of the spindle of the compact disc recorder is constant, that is, the compact disc recorder writes data in the CAV mode. When the compact disc recorder writes data onto the program area 18 of the compact disc 10, the compact disc recorder will determine the corresponding writing linear velocity according to the writing location of the desired data (step 112). Next, determine the velocity zone where this writing linear velocity belongs to and to interpolate the two reference linear velocities of the velocity zone according to the reference table 30 (step 114). In performing step 116, an interpolation method is used to determine the optimum writing power and the target reflected pulse level of the desired data according to the reference writing powers and the reference reflected pulse levels corresponding to the two reference linear velocities of the velocity zone. Step 18 uses the ROPC procedure to write data onto the compact disc 10 with the optimum writing power and the target reflected pulse level obtained in Step 116.

For example, if a writing linear velocity Vw of the desired data is between the reference velocity Vc and the reference velocity Vd of the reference table 30, the interpolation method can be used to determine the optimum writing power Pw and the target reflected pulse level Bw which are represented as follows.

$$\frac{( Vw - Vc )}{( Vd - Vc )} = \frac{( Pw - Pc )}{( Pd - Pc )} = \frac{( Bw - Bc )}{( Bd - Bc )}$$

After obtaining the optimum writing power Pw and the target reflected pulse level Bw of the desired data, the ROPC procedure is then performed to write data onto the compact disc 10. During the writing procedure, the compact disc recorder first utilizes the optimum writing power Pw to emit an incident writing pulse to etch the compact disc 10. Then, the compact disc recorder will continuously measure the reflected pulses reflected from the compact disc 10 and compare the level of the reflected pulses with the obtained target reflected pulse level Bw for adjusting the optimum writing power Pw used to write data onto the compact disc 10.

As above-mentioned, the present invention constructs the reference table 30 to divide the program area 18 of the compact disc 10 into a plurality of velocity zones, and then utilizes the interpolation method to quickly and accurately determine the optimum writing power Pw and the target reflected pulse level Bw of the desired data for performing the ROPC procedure. Of course, a designer can adjust the quantity of the velocity zones to obtain more accurate control results depending on the actual requirements of the system.

Although the reference table 30 of the present invention comprises a plurality of velocity zones, the target of the present invention can also be achieved by constructing two reference linear velocities, two corresponding reference writing powers, and two corresponding reference reflected pulse levels only. Furthermore, the two reference linear velocities are not limited to two linear velocities at the innermost radius and the outermost radius of the compact disc 10. Any two linear velocities between the innermost radius and the outermost radius of the compact disc 10 can serve as the two reference linear velocities. For each of the writing linear velocities of the desired data, the designer can utilize the two reference linear velocities to determine the corresponding writing power and the reflected pulse level by using the interpolation method, and then perform the ROPC procedure to write data into the program area of the compact disc 10.

In contrast to the prior art, the present invention constructs a reference table to determine reference writing powers and reference reflected pulse levels with respect to the reference linear velocities before writing data onto a compact disc. Then, to utilize the reference table to obtain the optimum writing power and the target reflected pulse level of certain desired data to perform the ROPC procedure to write data onto the compact disc. Therefore, the writing power control method of the present invention can easily and accurately adjust the optimum writing power and the target reflected pulse level of a linear velocities at any location of the compact disc so as to ensure the accuracy of the writing results and increase the efficiency of the whole system substantially.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A writing power control method of a compact disc drive for controlling a writing power used for writing data onto a compact disc;
the writing power control method comprising:
(a) dividing said compact disc into a plurality of writing zones according to a plurality of reference linear velocities, each of said plurality of reference linear velocities having a corresponding reference writing power and a corresponding reference reflected pulse level;
(b) obtaining a writing linear velocity of desired data;
(c) determining a target writing zone within said plurality of writing zones of said compact disc and two reference linear velocities of said target writing zone according to said writing linear velocity of desired data;
(d) determining an optimum writing power and a target reflected pulse level of said desired data according to the corresponding reference writing powers and the corresponding reference reflected pulse levels of said two reference linear velocities; and
(e) performing a running optimum power control (ROPC) procedure with said optimum writing power and said target reflected pulse level of said desired data for writing said desired data onto said compact disc.

2. The writing power control method of claim 1 wherein said compact disc comprises a power calibration area (PCA) for performing a power calibration, said plurality of reference linear velocities comprising a first reference linear velocity and a second reference linear velocity, the reference writing powers comprising a first reference writing power with respect to said first reference linear velocity and a second reference writing power with respect to said second reference linear velocity, and the writing power control method further comprises:
controlling a spin velocity of said compact disc for making a linear velocity of said power calibration area equal to said first reference linear velocity so as to determine said first reference writing power by performing said power calibration at said power calibration area;
controlling said spin velocity of said compact disc for making said linear velocity of said power calibration area equal to said second reference linear velocity so as to determine said second reference writing power by performing said power calibration at said power calibration area;
determining other reference linear velocities besides said first reference linear velocity and said second reference linear velocity according to said first reference linear velocity and said second reference linear velocity; and
determining other reference writing powers besides said first reference writing power and said second reference writing power according to said first reference writing power and said second reference writing power.

3. The writing power control method of claim 2 further comprising performing a writing test at said power calibration area with each reference linear velocity and each corresponding reference writing power, and reading a plurality of reflected pulses thereof for determining a plurality of said reference reflected pulse levels corresponding to the reference linear velocities.

4. The writing power control method of claim 1 wherein step(d) further comprises:
determining said optimum writing power of said desired data according to said writing linear velocity of said desired data, said two reference linear velocities of said target writing zone, the corresponding reference writing powers of said two reference linear velocities; and
determining said target reflected pulse level of said desired data according to said writing linear velocity of said desired data, said two reference linear velocities of said target writing zone, the corresponding reference reflected pulse levels of said two reference linear velocities.

5. A writing power control method of a compact disc drive for controlling a laser power used for writing data onto a program area of a compact disc, the compact disc comprising a power calibration area (PCA) for performing a power calibration;
the writing power control method comprising:
(a) dividing said program area into a plurality of writing zones according to a plurality of reference linear velocities, each of the reference linear velocities having a corresponding reference writing power and a corresponding reference reflected pulse level, said plurality of reference linear velocities comprising a first reference linear velocity and a second reference linear velocity, the reference writing powers comprising a first reference writing power with respect to said first reference linear velocity and a second reference writing power with respect to said second reference linear velocity;
wherein a procedure of dividing said program area into said plurality of writing zones comprises:
(a.1)controlling a spin velocity of the compact disc for making a linear velocity of said power calibration area equal to said first reference linear velocity so as to determine said first reference writing power by performing said power calibration at said power calibration area;
(a.2)controlling said spin velocity of the compact disc for making said linear velocity of said power calibration area equal to said second reference linear velocity so as to determine said second reference writing power by performing said power calibration at said power calibration area;
(a.3)determining other reference linear velocities besides said first reference linear velocity and said second reference linear velocity according to said first reference linear velocity and said second reference linear velocity;
(a.4)determining other reference writing powers besides said first reference writing power and the second reference writing power according to the first reference writing power and the second reference writing power; and
(a.5)performing a writing test at said power calibration area with each reference linear velocity and each corresponding reference writing power, and reading a plurality of reflected pulses thereof for determining a plurality of said reference reflected pulse levels corresponding to said plurality of reference linear velocities;
(b) obtaining a writing linear velocity of desired data; and
(c) determining an optimum writing power and a target reflected pulse level of said desired data according to said writing linear velocity of said desired data so as to perform a running optimum power control (ROPC) procedure for writing said desired data onto said program area of said compact disc;

6. The writing power control method of claim 5 wherein the step of determining said optimum writing power and said target reflected pulse level of said desired data comprises:
determining said optimum writing power of said desired data according to said writing linear velocity of said desired data, two reference linear velocities of a writing zone where said writing linear velocity belongs to, two corresponding reference writing powers of said two reference linear velocities; and
determining said target reflected pulse level of said desired data according to said writing linear velocity of said desired data, said two reference linear velocities of said writing zone where said writing linear velocity belongs to, two corresponding reference reflected pulse levels of said two reference linear velocities.

7. A writing power control method of a compact disc recorder for controlling a laser power used for writing data into a program area of a compact disc, said writing power control method comprising:
(a) calculating a plurality of reference linear velocities based on a constant angular velocity at different radii of said compact disc;
(b) making a linear velocity of a power calibration area on said compact disc equal to one of said plurality of reference linear velocities so as to determine a first reference writing power;
(c) making said linear velocity of said power calibration area on said compact disc equal to another one of said plurality of reference linear velocities so as to determine a second reference writing power;
(d) performing a writing test at said power calibration area with each of said plurality of reference linear velocities and the corresponding first and second reference writing powers, thus determining first and second reference reflected pulse levels respectively;
(e) obtaining a writing linear velocity of a desired data; and
(f) determining an optimum writing power and a target reflected pulse level of said desired data according to said writing linear velocity of said desired data so as to perform a running optimum power control (ROPC) procedure for writing said desired data into said program area of said compact disc.

8. The writing power control method of claim 7 further comprises a step of obtaining other reference writing powers according to said fist reference writing power, said second reference writing power and a distributing manner of said plurality of reference linear velocities.

9. The writing power control method of claim 8, wherein the step of performing said writing test at said power calibration area further comprises a step of determining other reference reflected pulse levels with each of said other reference writing powers and the corresponding reference linear velocity.

10. The writing power control method of claim 7 wherein the step of determining said optimum writing power and said target reflected pulse level of said desired data comprises:
determining said optimum writing power of said desired data according to said writing linear velocity of said desired data, two of said plurality of reference linear velocities and the corresponding first and second reference writing powers; and
determining said target reflected pulse level of said desired data according to said writing linear velocity of said desired data, two of said plurality of reference linear velocities and the corresponding first and second reference reflected pulse levels.
